(19) United States
(12) Patent Application Publication
(10) Pub. No.: US 2011/0154436 A1
(43) Pub. Date: Jun. 23, 2011

(54) Provider Management Methods and Systems for a Portable Device Running Android Platform

(75) Inventors: Jian-Ming Jian, Daliao Township (TW); Hung-Ta Lee, Zhubei City (TW); Chia-Hsien Lu, Banqiao City (TW)

(73) Assignee: MEDIATEK INC., Hsin-Chu (TW)

(21) Appl. No.: 12/900,287

(22) Filed: Oct. 7, 2010

Related U.S. Application Data
(60) Provisional application No. 61/288,467, filed on Dec. 21, 2009.

(51) Int. Cl. H04L 9/32; G06F 9/46; G06F 13/00

(52) U.S. Cl. 726/2; 719/331

(57) ABSTRACT

A provider management method conforming to an Android platform is provided. An authentication procedure is performed between a consumer and a provider, wherein the authentication procedure is performed via a binding unit, and the binding unit is an interface enabling inter-process communication conforming to the Android platform.

### CROSS REFERENCE TO RELATED APPLICATIONS

This Application claims priority of U.S. Provisional Application No. 61/288467, filed on Dec. 21, 2009, the entirety of which is incorporated by reference herein.

### BACKGROUND OF THE INVENTION

1. Field of the Invention

The invention relates to provider management methods, and more particularly to provider management methods and systems for a portable device running an Android platform.

2. Description of the Related Art

With development of portable devices, more and more functionalities and platforms are being developed for the portable devices. The “Android” platform (Android), is an operating system for mobile devices such as mobile phones, tablet computers and netbooks. Android is based upon the Linux kernel and GNU software. It is positioned in the Open Handset Alliance, and is one of the available options for portable device users.

Android allows developers to write managed code in Java language, so that a device may be controlled via Google-developed Java libraries. Android is a Linux-based operating system that includes Linux kernel, middleware and key applications. In an Android platform, a IBinder is provided to perform binding operations between services such that a client unit (e.g. an application), which is requesting a service, may be able to obtain an interface, to in turn access the service through the IBinder, by using function calls.

For the current Android platform, after an interface for accessing a service is obtained via the IBinder, the client unit which is requesting the service can directly access the service and functionalities of the service.

### BRIEF SUMMARY OF THE INVENTION

Provider management methods conforming to an Android platform and provider management systems in portable devices running an Android platform are provided. An exemplary embodiment of a provider management method conforming to an Android platform is provided. An authentication procedure is performed between a consumer and a provider, wherein the authentication procedure is performed via a binding unit, and the binding unit is an interface enabling inter-process communication conforming to the Android platform.

Moreover, an exemplary embodiment of a provider management system in a portable device running an Android platform is provided and comprises a binding unit and a provider. The binding unit is an interface enabling inter-process communication conforming to the Android platform. An authentication procedure is performed between a consumer and the provider via the binding unit.

Provider management methods conforming to an Android platform may take the form of a computer program embodied in a tangible media. When the computer program is executed by a device, the device becomes an apparatus for practicing the disclosed method.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a schematic diagram illustrating a provider management system according to an embodiment of the present invention;

FIG. 2 is a flow chart showing an embodiment of a provider management method conforming to an Android platform according to the invention;

FIG. 3 is a flow chart showing an embodiment of a provider management method for authentication against a consumer according to the invention;

FIG. 4 is a flow chart showing another embodiment of a provider management method for authentication against a consumer according to the invention; and

FIG. 5 is a flow chart showing yet another embodiment of a provider management method for authentication against a provider according to the invention.

### DETAILED DESCRIPTION OF THE INVENTION

The following description is of the best-contemplated mode of carrying out the invention. The description is made for the purpose of illustrating the general principles of the invention and should not be taken in a limiting sense. The scope of the invention is best determined by reference to the appended claims.

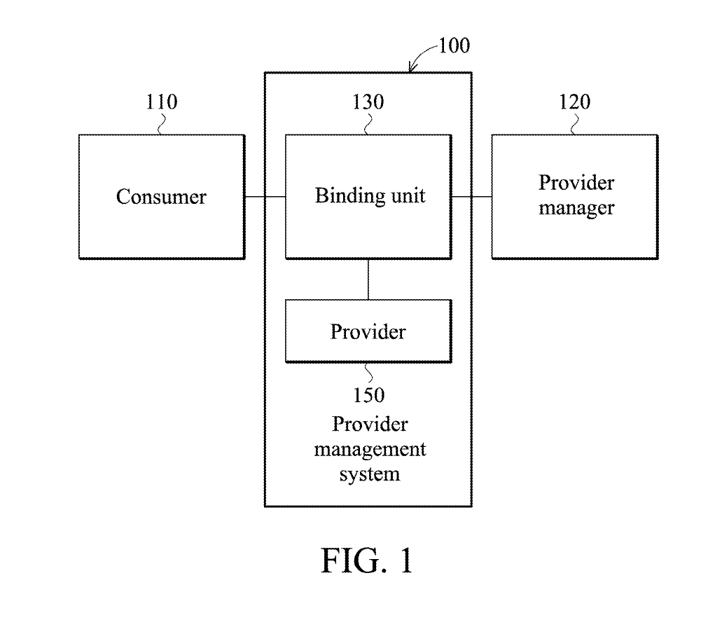

FIG. 1 is a schematic diagram illustrating a provider management system 100 according to an embodiment of the present invention. The provider management system 100 may be applied in any portable device, for example, mobile phone, tablet computer and netbook, but is not limited thereto. Particularly, the provider management system 100 may be applied in a portable device running the Android platform. The provider management system 100 may comprise a binding unit 130 and at least one provider 150. The binding unit 130 is an interface which enables an inter-process communication conforming to the Android platform. An example of the binding unit 130 is IBinder in Android Platform. IBinder is an interface to enable IPC, which is a set of techniques for the exchange of data among multiple threads in one or more processes in an Android platform and is a base class and low-level protocol for a remote object. An IBinder class may support both a remote (inter-processes) and local (intra-process) communications. Anyone may simply communicate with a provider, such as service, to access provided services via an IBinder. The provider 150 can be, for example, a service, a framework, etc. A consumer 110, which may be referred to as a provider user (e.g. an application (hereinafter referred to as AP)), can be executed on the Android platform and may request for accessing the provider 150. An authentication procedure could be performed between the consumer 110 (e.g. an AP) and the provider 150. The authentication procedure is performed via the binding unit 130. The authentication procedure could be performed for many purposes, such as for determining whether the consumer 110 can access the provider 150 or not, for the provider 150 to decide on taking the data sent by the consumer 110 or not, for the consumer 110 to decide on taking the data sent by the provider 150 or not, etc. Detailed description of the authentication procedure between the consumer 110 and the provider 150 will be provided later.

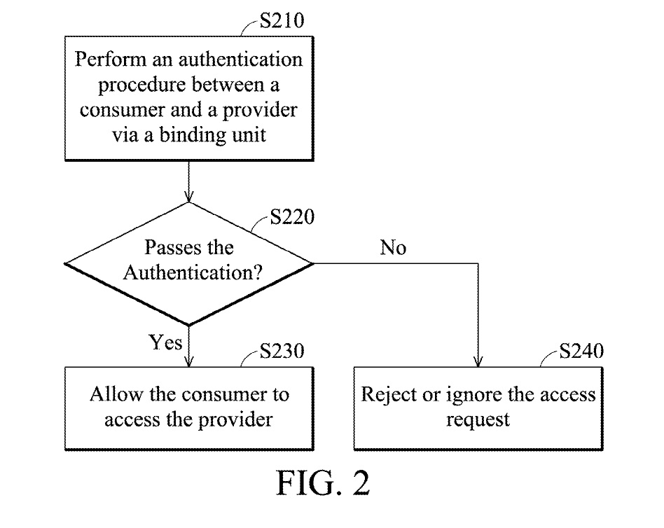

Provider management methods conforming to an Android platform are provided. FIG. 2 is a flow chart showing an embodiment of a provider management method conforming to an Android platform according to the invention. The method can be applied in a portable device with the provider management system 100. According to the invention, the authentication procedures between the consumer 110 (e.g. an AP) and the provider 150 (e.g. a service) may be performed to verify whether the consumer is a registered or authenticated consumer 110 or not, efficiently preventing the provider 150 from being accessed by unauthenticated consumers. In step S210, an authentication procedure is performed between the consumer 110 and the provider 150 via the binding unit 130. The binding unit 130 is an interface which enables an inter-process communication conforming to the Android platform. To perform the authentication procedure, consumer 110 can send authentication information to the provider 150 via the binding unit 130, and the provider 150 can verify the authentication information. The authentication information can be an identification corresponding to the consumer 110, a signature, a runtime binary size of the consumer 110, or any information for the provider 150 to authenticate the consumer 110. The signature can be a digital signature. The result of the authentication procedure is determined in step S220. If the consumer 110 passes the authentication, it is an authenticated or legal consumer, such as an application (AP), and is allowed to access the provider 150 (step S230). If the consumer 110 does not pass the authentication, the consumer 110 is not an authenticated or legal consumer, such as AP, and thus the consumer 110 is not allowed to access the provider 150 such that the provider access request by the consumer 110 is rejected or ignored (step S240). In some embodiments, if the consumer 110 does not pass the authentication, the consumer 110 may be allowed to access the provider 150, but may not be allowed to use the functionalities of the provider 150. For example, the provider 150 may provide a blank or false result to the consumer 110 when preventing the functionalities of the provider 150 from being accessed by an unauthenticated consumer 110.

In some embodiments, a third party can take care of the authentication procedure. The consumer 110 can send authentication information to a third party via the binding unit 130, and the third party can verify the authentication information and inform the provider 150 of whether the consumer 110 passes the authentication or not. In some embodiments, either before or after the authentication procedure, the consumer 110 may further send an identification corresponding to itself to the provider 150, thus the provider 150 can identify the consumer 110. In some embodiments, the third party may be a hardware module or may not be located in the system where the binding unit 130 and the provider 150 are, the communication between the consumer 110 and the third party and the communication between the provider 150 and the third party may not be conducted via binding unit 130.

In one embodiment, the consumer 110 may obtain a handle corresponding to the provider 150 first, and then the authentication procedure is performed between the consumer 110 and the provider 150. The consumer 110 may obtain the handle corresponding to the provider 150 from the provider manager 120 (as shown in FIG. 1) through the binding unit 130. In another embodiment, the authentication procedure may be performed via a third party first, and then a handle corresponding to the provider 150 is provided to the consumer 150 by the third party or the provider 150.

In some cases, the consumer 110, such as an application, may have been tampered. To prevent a tampered consumer 110 from accessing the provider 150, an authentication procedure can be performed between the consumer 110 and the provider 150 via the binding unit 130. The authentication information provided by the consumer 110 may include a runtime binary size of the consumer 110 (e.g. an application). Thus the provider 150 can verify the authentication information, for example, check if the runtime binary size is the same as a registered binary size. The registered binary size can be a binary size of an original, not tampered consumer 110 registered previously. In some embodiments, an identification corresponding to the registered binary size can be given to the original, not tampered consumer 110, then the consumer 110 can send the runtime binary size along with the identification corresponding to the registered binary size to the provider 150 for the provider 150 to check if the runtime binary size is the same as a registered binary size. The identification corresponding to the registered binary size can be generated by encrypting the registered binary size by, for example but not limited thereto, the provider 150.

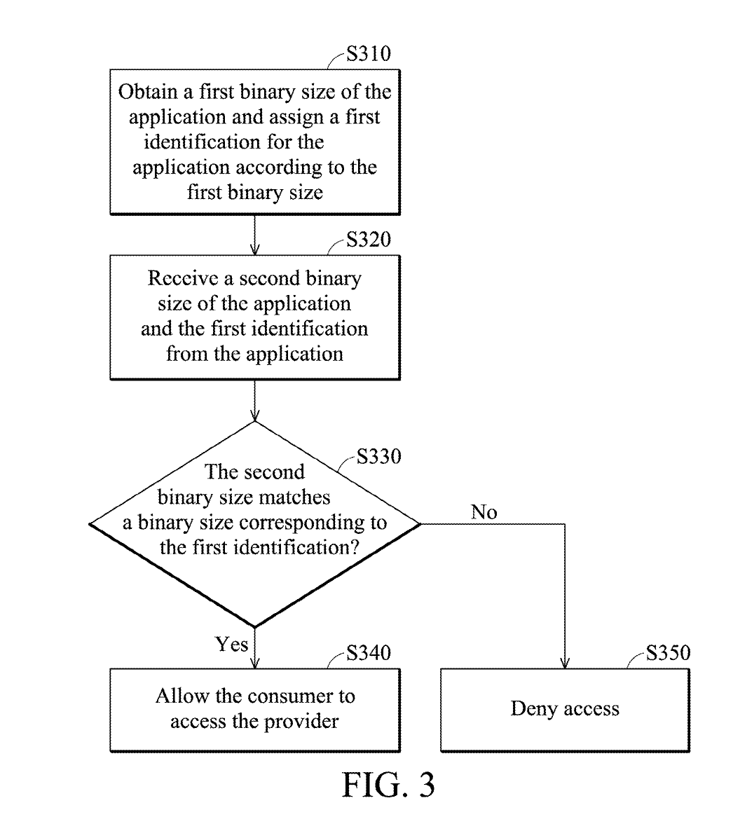

FIG. 3 is a flow chart showing another embodiment of a provider management method for authentication against a consumer according to the invention. In step S310, a first binary size (e.g. registered binary size) of the consumer 110 (e.g. an AP) may be obtained, e.g. from a knowledge database, and a first identification can be assigned for the consumer 110 according to the first binary size. For example, the provider 150 may encrypt the first binary size by any encryption algorithms known in the art (e.g. by a hash function) to obtain the first identification. The first identification may later be used to verify whether the consumer 110 has been tampered during runtime. When the provider 150 is approached, in step S320, authentication information including a second binary size (e.g. runtime binary size) of the consumer 110 and the first identification are received from the consumer 110. In this step, the provider 150 may obtain the authentication information from the consumer 110 via the binding unit 130. In step S330, it is determined whether the second binary size matches a binary size corresponding to the first identification by provider 150. Note that the consumer 110 is determined as an authenticated consumer when the second binary size (e.g. the runtime binary size) is the same as the first binary size (e.g. the registered binary size). It is understood that the registered binary size of the consumer 110 may be derived from the first identification by using a corresponding decryption algorithm. When the second binary size matches the binary size corresponding to the first identification (Yes in step S330), the consumer 110 may not be tampered before approaching the provider 150, then in step S340, the consumer 110 is allowed to access the provider 150. Otherwise (No in step S330), the consumer 110 may have been tempered, then in step S350, the access by the consumer 110 is denied. By doing so, an unregistered or tampered consumer 110 is prevented from accessing the provider 150.

In some embodiments, authentication information can be transferred along with confidential data between the consumer 110 and the provider 150 via the binding unit 130, thus a safe channel of transferring confidential data between the consumer 110 and the provider 150 can be established.

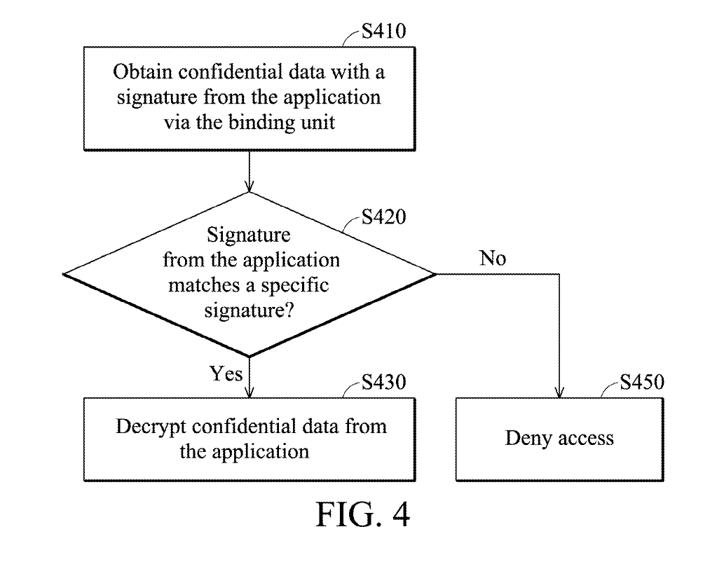

In one embodiment, the provider 150 may receive authentication information or confidential data along with the authentication information from the consumer 110 and then verify the authentication information to perform the authentication procedure. FIG. 4 is a flow chart showing an embodiment of a provider management method for authentication against a consumer according to the invention. The method can be applied in a portable device with the provider management system 100. In step S410, the provider 150 (e.g. service) may obtain confidential data with authentication information (e.g. a signature) from the consumer 110 (e.g. application) via the binding unit 130. In step S420, the provider 150 may verify the authentication information (e.g. signature) by, for example, determining whether the signature from the consumer 110 matches a specific signature. If the signature from the consumer 110 matches the specific signature (Yes in step S420), the consumer 110 passes the authentication procedure. Then in step S430, the confidential data from the consumer 110 can be decrypted. If the signature from the consumer 110 does not match the specific signature (No in step S420), the consumer 110 does not pass the authentication procedure, which means it may be an unauthorized or unlicensed consumer 110. Then in step S450, the consumer 110 may not be allowed to access the provider 150. The confidential data from the consumer 110 may not be decrypted. Further, the consumer 110 may be unloaded and operation thereof will be halted. By doing so, unauthorized or unlicensed consumer 110 can be detected.

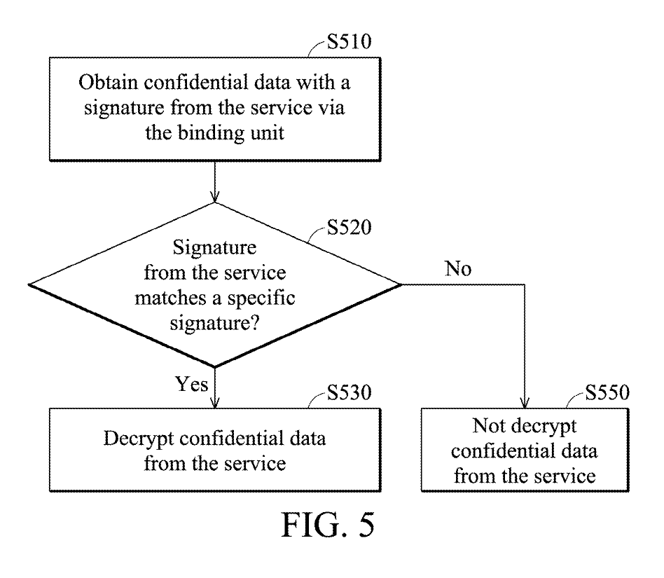

In some embodiments, the provider 150 may want to transfer confidential data to the consumer 110, for example, in response to a query from the consumer 110. The confidential data can be key, ID or password to the provider 150, or any data the provider 150 wants to keep confidential. Then the provider 150 may send the confidential data to the consumer 110 along with authentication information for the consumer 110 to verify. FIG. 5 is a flow chart showing an embodiment of a provider management method for authentication against a provider according to the invention. The method can be applied in a portable device with the provider management system 100. In step S510, the consumer 110 (e.g. application) may obtain confidential data with authentication information (e.g. a signature) from the provider 150 (e.g. service) via the binding unit 130. In step S520, the consumer 110 may verify the authentication information (e.g. signature) by, for example, determining whether the signature from the provider 150 matches a specific signature. If the signature from the provider 150 matches the specific signature (Yes in step S520), the provider 150 passes the authentication procedure. Then in step S530, the confidential data from the provider 150 can be decrypted. If the signature from the provider 150 does not match the specific signature (No in step S520), the provider 150 does not pass the authentication procedure, which means it may be an unauthorized provider 150. Then in step S550, the consumer 110 may not decrypt the confidential data from the provider 150. By doing so, unauthorized provider 150 can be detected.

In sum, according to the provider management method and provider management system applied in a portable device of the invention, an authentication procedure between a consumer and a provider can be performed via the binding unit, which is an interface enabling inter-process communication conforming to the Android platform (e.g. IBinder). The authentication procedure can help determine whether a consumer can access a provider or not, help the provider decide on taking the data sent by the consumer or not, for the consumer decide on taking the data sent by the provider, etc. Therefore the provider (e.g. service) can be prevented from being accessed by unauthorized customer (e.g. AP). Besides, a safe channel for transferring confidential data between the provider and the consumer can be established.

Provider management methods conforming to a particular communication platform like an Android platform, or certain aspects or portions thereof, may take the form of program code (i.e., executable instructions) embodied in tangible media, such as products, floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A provider management method conforming to an Android platform, comprising:
performing an authentication procedure between a consumer and a provider;
wherein the authentication procedure is performed via a binding unit, and the binding unit is an interface enabling inter-process communication conforming to the Android platform.

2. The provider management method as claimed in claim 1, wherein the authentication procedure is performed against the consumer in response to a request for accessing the provider by the consumer, and the method further comprises:
determining whether to allow the consumer to access the provider according to the result of the authentication procedure.

3. The provider management method as claimed in claim 1, further comprises:
providing a handle corresponding to the provider to the consumer.

4. The provider management method as claimed in claim 1, wherein the step of performing the authentication procedure comprises:
receiving authentication information from the consumer; and
verifying the authentication information.

5. The provider management method as claimed in claim 4, wherein the authentication information comprises a binary size of the consumer and the step of verifying includes checking if the binary size is the same as a registered binary size.

6. The provider management method as claimed in claim 5, wherein the authentication information further comprises an identification corresponding to the registered binary size.

7. The provider management method as claimed in claim 4, wherein the authentication information comprises an identification corresponding to the consumer.

8. The provider management method as claimed in claim 4, wherein the authentication information comprises a signature.

9. The provider management method as claimed in claim 4, wherein the step of receiving further comprises receiving data along with the authentication information from the consumer, and the method further comprises:
decrypting the data when the authentication information passes.

10. The provider management method as claimed in claim 1, wherein the step of performing the authentication procedure comprises:
sending authentication information to the consumer.

11. The provider management method as claimed in claim 10, wherein the step of sending further comprises sending data along with the authentication information to the consumer.

12. The provider management method as claimed in claim 1, wherein the step of performing the authentication procedure comprises:
sending authentication information to the provider.

13. The provider management method as claimed in claim 12, wherein the step of sending further comprises sending data along with the authentication information to the provider.

14. The provider management method as claimed in claim 1, wherein the step of performing the authentication procedure comprises:
receiving authentication information from the provider.

15. The provider management method as claimed in claim 14, wherein the step of receiving further comprises receiving data along with the authentication information from the provider.

16. A provider management system in a portable device running an Android platform, comprising:
a binding unit, being an interface enabling inter-process communication conforming to the Android platform; and
a provider;
wherein an authentication procedure is performed between a consumer and the provider via the binding unit.

17. The provider management system as claimed in claim 16, wherein the authentication procedure is performed against the consumer in response to a request for accessing the provider by the consumer, and whether to allow the consumer to access the provider is determined according to the result of the authentication procedure.

18. The provider management system as claimed in claim 16, wherein a handle corresponding to the provider is provided to the consumer.

19. The provider management system as claimed in claim 16, wherein the provider receives authentication information from the consumer and verifies the authentication information.

20. The provider management system as claimed in claim 19, wherein the authentication information comprises a binary size of the consumer and the provider checks if the binary size is the same as a registered binary size.

21. The provider management system as claimed in claim 20, wherein the authentication information further comprises an identification corresponding to the registered binary size.

22. The provider management system as claimed in claim 19, wherein the authentication information comprises an identification corresponding to the consumer.

23. The provider management system as claimed in claim 19, wherein the authentication information comprises a signature.

24. The provider management system as claimed in claim 19, wherein the provider receives data along with the authentication information from the consumer and decrypts the data when the authentication information passes.

25. The provider management system as claimed in claim 16, wherein the provider sends authentication information to the consumer to perform the authentication procedure.

26. The provider management system as claimed in claim 25, wherein the provider sends data along with the authentication information to the consumer.

27. A machine-readable storage medium comprising a computer program, which, when executed, causes a device to perform a provider management method conforming to an Android platform, wherein the method comprises:
performing an authentication procedure between a consumer and a provider;
wherein the authentication procedure is performed via a binding unit, and the binding unit is an interface enabling inter-process communication conforming to the Android platform.
